(19) United States
(12) Patent Application Publication
(10) Pub. No.: US 2026/0131337 A1
(43) Pub. Date: May 14, 2026

(54) MULTI-FUNCTIONAL SHOWERHEAD

(71) Applicant: Xiamen Jaslen Sanitary Ware Co., Ltd, Xiamen (CN)

(72) Inventors: Run CHEN, Xiamen (CN); Huiming LAI, Xiamen (CN); Lijun XIAO, Xiamen (CN)

(73) Assignee: Xiamen Jaslen Sanitary Ware Co., Ltd, Xiamen (CN)

(21) Appl. No.: 19/006,229

(22) Filed: Dec. 31, 2024

(30) Foreign Application Priority Data
Nov. 14, 2024 (CN) 2024227818041

(51) Int. Cl. B05B 1/16; B05B 12/00

(52) U.S. Cl. CPC B05B 1/1636; B05B 12/002

(57) ABSTRACT

The present invention provides a multi-functional showerhead. The showerhead main body is provided with a water inlet channel, a first mounting cavity, a second mounting cavity, a rotating switching water outlet panel, a showerhead water passing channel, a spray gun water passing channel, and a spray gun water outlet channel. The water inlet channel is communicated with the showerhead water passing channel or the spray gun water passing channel through a switching action of the first switching switch, and the spray gun water passing channel is communicated with the spray gun water outlet nozzle or disconnected with the spray gun water outlet nozzle to form a water suspension state through a switching action of the second switching switch.

### CROSS-REFERENCE TO RELATED APPLICATIONS

The application claims priority to Chinese patent application No. 2024227818041, filed on Nov. 14, 2024, the entire contents of which are incorporated herein by reference.

### TECHNICAL FIELD

The present invention relates to the technical field of kitchens and bathrooms, and in particular, to a multi-functional showerhead.

### BACKGROUND

As the requirements of consumers change and increase, showerheads have more and more water outlet functions, such as an additional spray gun water function. However, for the showerhead on the current market, a plurality of water outlet modes of the showerhead are usually integrated into the same control switch, resulting in an accidental touch by a user. In addition, when the existing showerhead is equipped with the spray gun water function, a water suspension function is not specially equipped for the spray gun function, and the water needs to be suspended through a faucet, bringing inconvenience to use. Therefore, the present invention provides a multi-functional showerhead, to solve the above technical problems.

### SUMMARY

To solve the above technical problems, the present invention provides a showerhead structure with more water outlet functions.

A multi-functional showerhead includes a showerhead main body, a first switching switch, and a second switching switch.

The showerhead main body is provided with a water inlet channel, a first mounting cavity, a second mounting cavity, a rotating switching water outlet panel, a showerhead water passing channel, a spray gun water passing channel, and a spray gun water outlet channel. Specifically, the water inlet channel is communicated with a water inlet of the first mounting cavity, the rotating switching water outlet panel is communicated with the first mounting cavity through the showerhead water passing channel, the second mounting cavity is communicated with the first mounting cavity through the spray gun water passing channel, the spray gun water outlet channel is communicated with the second mounting cavity, and a spray gun water outlet nozzle communicated with the spray gun water outlet channel is circumferentially disposed on a showerhead head portion of the showerhead main body.

During mounting, the first switching switch is mounted in the first mounting cavity, and the second switching switch is mounted in the second mounting cavity and is provided with a spray gun water gear and a water suspension gear. During use, the water inlet channel is communicated with the showerhead water passing channel or the spray gun water passing channel through a switching action of the first switching switch, so that the showerhead may be controlled to discharge spray gun water or showerhead water. In a state of discharging the spray gun water, the spray gun water passing channel is communicated with the spray gun water outlet nozzle or disconnected with the spray gun water outlet nozzle to form a water suspension state through a switching action of the second switching switch, so that the spray gun water may be discharged or a water suspension state is formed. In a state of discharging the showerhead water, when the rotating switching water outlet panel is rotated, showerhead water of different states may be discharged.

The showerhead provided in the present invention has a showerhead water function and a spray gun water function. During use, the first switching switch may be used to implement switching between the showerhead water and the spray gun water, and the second switching switch may be used to switch to discharge the spray gun water or form the water suspension state, thereby meeting a requirement of controlling water suspension at a showerhead end of the user. In addition, switching structures of the spray gun water and the showerhead water are independent of each other, which may avoid incorrect use of the user.

Preferably, the first switching switch adopts a pressing switch, or the first switching switch adopts a ball-point pen progressive pressing switching switch, which is simple and reliable in structure.

Preferably, the first mounting cavity is disposed in a handle of the showerhead main body, and the first switching switch is disposed on one side facing a user, to facilitate use.

Preferably, the second mounting cavity is disposed on a back portion of the showerhead head portion, and the second switching switch is a push button switch, which is more in line with gripping and switching manners of the user for the showerhead during use of the spray gun water.

Preferably, the second switching switch includes a swinging docking pipe, a water inlet end of the swinging docking pipe is docked with a water outlet end of the spray gun water passing channel in a swinging manner through a ball head, and a side wall, communicated with the spray gun water outlet channel, of the second mounting cavity is of an arc shape and is concentrical with the ball head. A swinging plug is disposed at a water outlet end of the swinging docking pipe, an end surface of the swinging plug is also of an arc shape and abuts against the side wall to perform a reciprocating movement, the end surface of the swinging plug is provided with a water passing hole, and the water passing hole is communicated or staggered with the spray gun water outlet channel through swinging of the swinging docking pipe, so that the swinging docking pipe can allow water to pass through and can play a role of switching to discharge water or suspend water.

Preferably, the second switching switch includes a swinging rod, one end of the swinging rod is rotatably mounted in the second mounting cavity, the other end thereof is provided with a swinging plug, the swinging plug is tightly attached to a bottom surface of the second mounting cavity to move, and a movement trajectory of the swinging plug is provided with a communicating hole that is between the spray gun water outlet channel and the second mounting cavity, so that switching of a spray gun water path is implemented through swinging of the swinging rod.

Preferably, the swinging plug is provided with a convex column, the second switching switch further includes a push button, the push button is slidably mounted on the showerhead head portion through a sliding groove, the push button is provided with an inclined groove allowing the convex column to be inserted, to facilitate a switching operation, a movement direction of the push button is parallel to a plane at which a central axis of a handle is located, the push button drives the swinging plug to move through the inclined groove and the convex column, and the movement trajectory of the swinging plug is perpendicular to the plane at which the central axis of the handle is located.

Preferably, the push button is slidably mounted in the sliding groove through an undercut.

Preferably, three spray gun water outlet channels are formed on an end portion of the showerhead head portion side by side.

Preferably, the rotating switching water outlet panel is rotatably mounted on the showerhead head portion, is provided with a water inlet switching cavity, and is further provided with a plurality of showerhead water outlet channels and showerhead water outlet nozzles that are in one-to-one correspondence. The water inlet switching cavity is communicated with the first mounting cavity through the showerhead water passing channel, and the showerhead water passing channel is communicated with any showerhead water outlet nozzle through a rotating action of the rotating switching water outlet panel, to switch a showerhead water state.

Preferably, a filter cartridge is disposed in the water inlet channel, which may improve water quality of discharged water.

Preferably, the multi-functional showerhead further includes a showerhead housing, the showerhead main body is mounted in an opening of a head portion of the showerhead housing, and subsequently, the rotating switching water outlet panel is rotatably mounted on the showerhead main body through a screw.

It can be known from the above description of the present invention that the present invention has the following beneficial effects:
1. The showerhead provided in the present invention has a showerhead water function and a spray gun water function. During use, the first switching switch may be used to implement switching between the showerhead water and the spray gun water, and the second switching switch may be used to switch to discharge the spray gun water or form the water suspension state, thereby meeting a requirement of controlling water suspension at a showerhead end of the user. In addition, switching structures of the spray gun water and the showerhead water are independent of each other, which may avoid incorrect use of the user.
2. The first switching switch adopts a pressing switch, which is simple and reliable in structure. The second switching switch is a push button switch and is disposed on the back of the showerhead head portion, which is more in line with gripping and switching manners of the user for the showerhead during use of the spray gun water.
3. The second switching switch adopts the swinging docking pipe or the swinging rod, which is simple in structure, easy to mount, and easy and convenient to switch.
4. The push button is docked with the convex column of the swinging plug through the inclined groove, so that movement directions of the push button and the swinging plug may be different or even perpendicular to each other. Therefore, the movement direction of the push button is parallel to the plane at which the central axis of the handle is located. Body mechanics is met, and use convenience is improved.
5. The second switching switch is provided with the water suspension gear, thereby implementing water suspension at the showerhead, which can be applied to the spray gun water state and the showerhead water state.

### BRIEF DESCRIPTION OF THE DRAWINGS

The accompanying drawings described herein are intended for further understanding of the present invention and constitute a part of the present invention. Schematic embodiments of the present invention and descriptions thereof are intended to explain the present invention, and do not constitute any inappropriate limitation on the present invention.

In the accompanying drawings:

FIG. 1 is an axial side view 1 of a multi-functional showerhead;

FIG. 2 is an axial side view 2 of a multi-functional showerhead;

FIG. 3 is an axial side view 3 of a multi-functional showerhead; (sectional state)

FIG. 4 is an exploded view 1 of a multi-functional showerhead;

FIG. 5 is an exploded view 2 of a multi-functional showerhead;

FIG. 6 is a sectional view 1 of a multi-functional showerhead; (showerhead water state)

FIG. 7 is a sectional view 2 of a multi-functional showerhead; (spray gun water state)

FIG. 8 is a sectional view 3 of a multi-functional showerhead; (water suspension gear) and

FIG. 9 is a sectional view 4 of a multi-functional showerhead. (spray gun water gear)

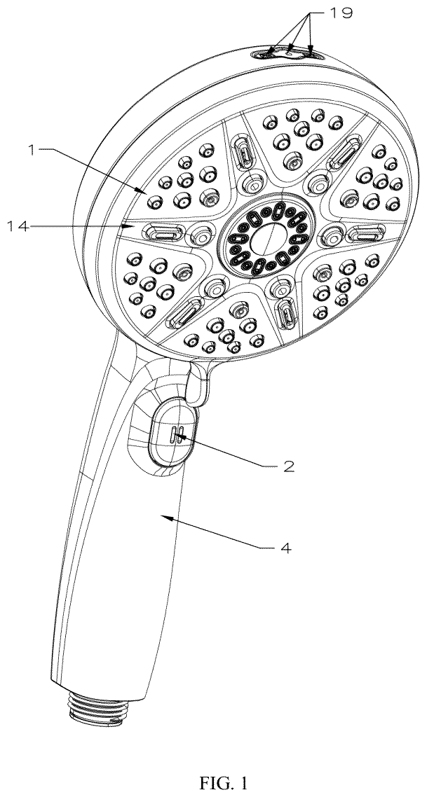

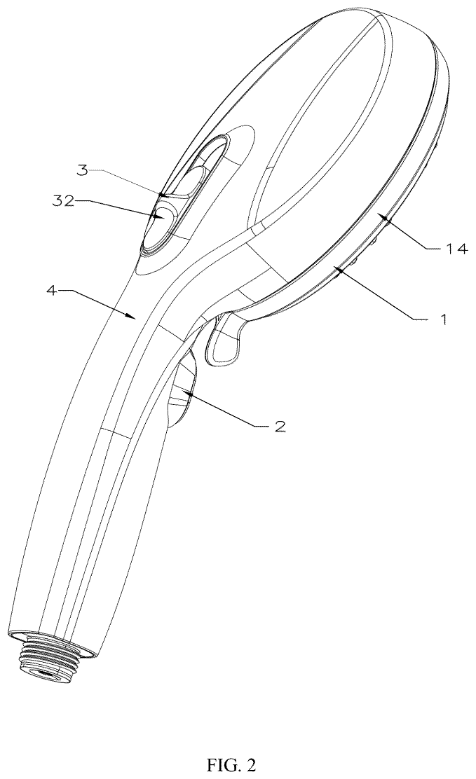

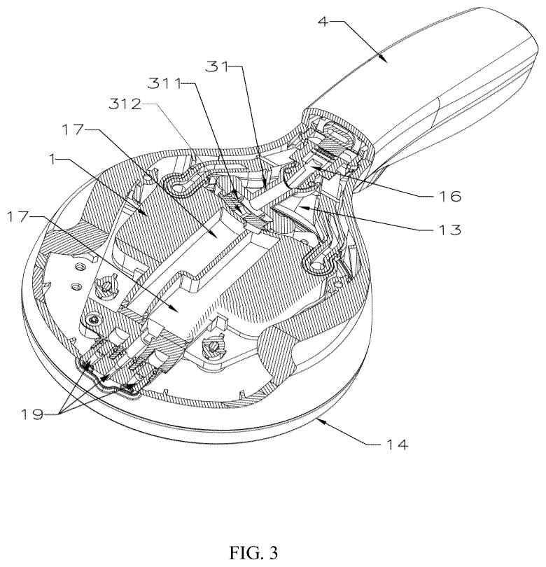

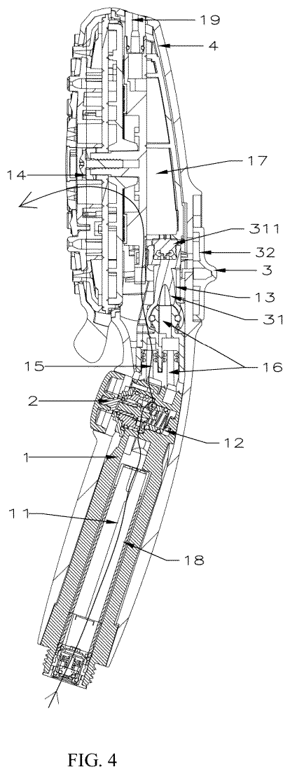

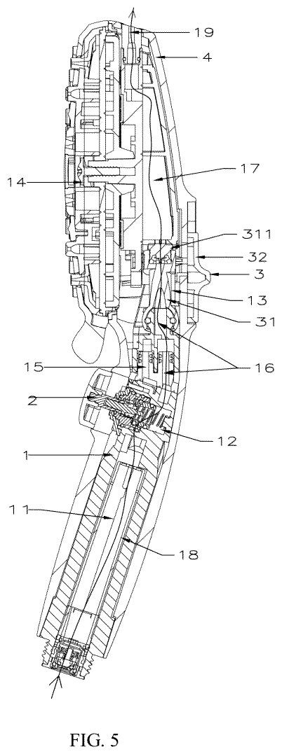

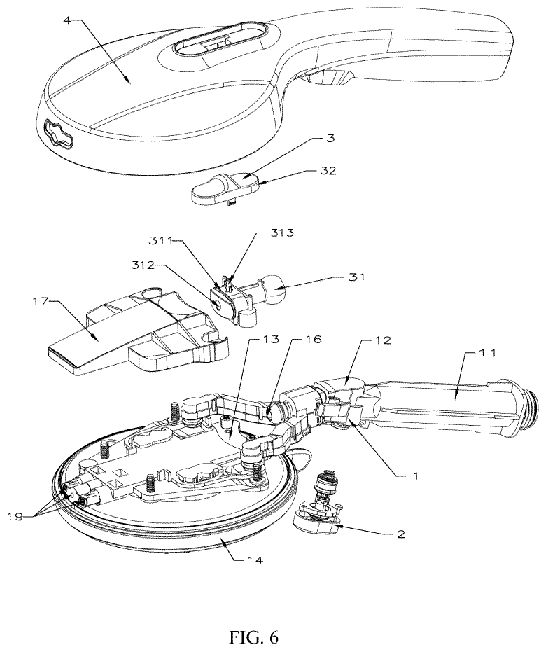

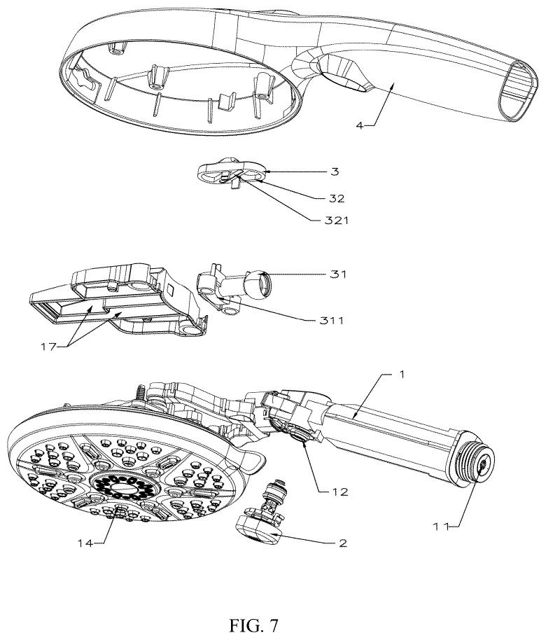

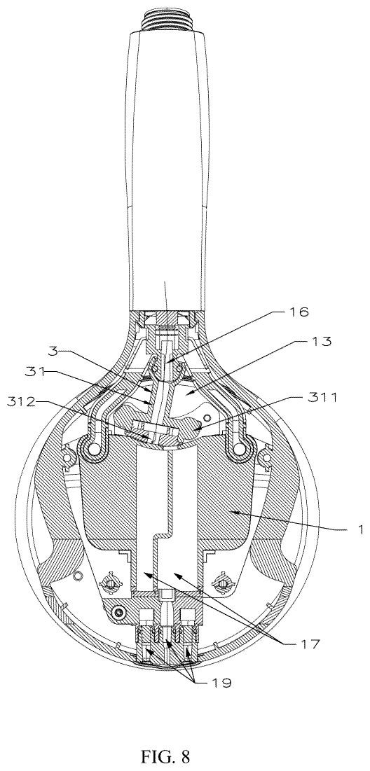

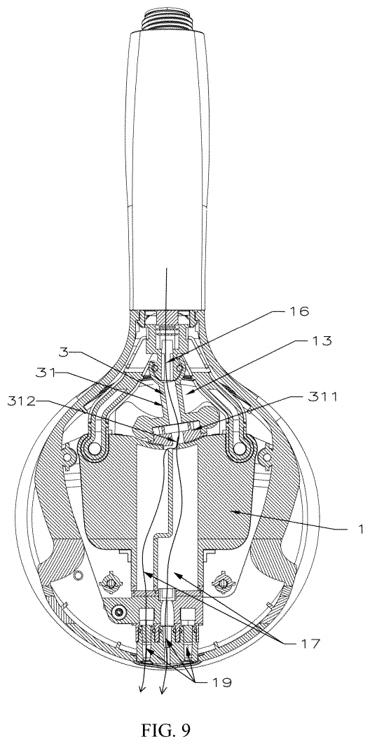

Reference numerals in FIG. 1 to FIG. 9 respectively are: 1. showerhead main body; 11. water inlet channel; 12. first mounting cavity; 13. second mounting cavity; 14. rotating switching water outlet panel; 15. showerhead water passing channel; 16. spray gun water passing channel; 17. spray gun water outlet channel; 18. filter cartridge; 19. spray gun water outlet nozzle; 2. first switching switch; 3. second switching switch; 31. swinging docking pipe; 311. swinging plug; 312. water passing hole; 313. convex column; 32. push button; 321. inclined groove; 4. showerhead housing.

### DETAILED DESCRIPTION OF THE EMBODIMENTS

To make the technical problems to be solved, technical solutions, and beneficial effects in the present invention clearer and more comprehensible, the following further describes the present invention in detail with reference to the accompanying drawings and embodiments. It should be understood that, the specific embodiments described herein are merely used to explain the present invention but not to limit the present invention.

Referring to FIG. 1 to FIG. 9, a multi-functional showerhead includes a showerhead main body 1, a first switching switch 2, and a second switching switch 3.

The showerhead main body 1 is provided with a water inlet channel 11, a first mounting cavity 12, a second mounting cavity 13, a rotating switching water outlet panel 14, a showerhead water passing channel 15, a spray gun water passing channel 16, and a spray gun water outlet channel 17. Specifically, a filter cartridge 18 is disposed in the water inlet channel 11, which may improve water quality of discharged water. The water inlet channel 11 is communicated with a water inlet of the first mounting cavity 12, the rotating switching water outlet panel 14 is communicated with the first mounting cavity 12 through the showerhead water passing channel 15, the second mounting cavity 13 is communicated with the first mounting cavity 12 through the spray gun water passing channel 16, the spray gun water outlet channel 17 is communicated with the second mounting cavity 13, and a spray gun water outlet nozzle 19 communicated with the spray gun water outlet channel 17 is circumferentially disposed on a showerhead head portion of the showerhead main body 1.

During mounting, the first switching switch 2 is mounted in the first mounting cavity 12, and the second switching switch 3 is mounted in the second mounting cavity 13. Preferably, the multi-functional showerhead further includes a showerhead housing 4. The showerhead main body 1 is mounted in an opening of a head portion of the showerhead housing 4, and subsequently, the rotating switching water outlet panel 14 is rotatably mounted on the showerhead main body 1 through a screw.

During use, the water inlet channel 11 is communicated with the showerhead water passing channel 15 or the spray gun water passing channel 16 through a switching action of the first switching switch 2, so that the showerhead may be controlled to discharge spray gun water or showerhead water.

In a state of discharging the spray gun water, the spray gun water passing channel 16 is communicated or disconnected with the spray gun water outlet nozzle 19 through a switching action of the second switching switch 3, so that the spray gun water may be discharged or a water suspension state is formed. In the embodiment, three spray gun water outlet nozzles 19 are disposed on an end portion of the showerhead head portion side by side.

In a state of discharging the showerhead water, when the rotating switching water outlet panel 14 is rotated, showerhead water of different states may be discharged. In the embodiment, the rotating switching water outlet panel 14 is rotatably mounted on the showerhead head portion, is provided with a water inlet switching cavity, and is further provided with a plurality of showerhead water outlet channels and showerhead water outlet nozzles that are in one-to-one correspondence. The water inlet switching cavity is communicated with the first mounting cavity 12 through the showerhead water passing channel 15, and the showerhead water passing channel 15 is communicated with any showerhead water outlet nozzle through a rotating action of the rotating switching water outlet panel 14, to switch a showerhead water state. Since a rotating switching water outlet structure is an existing technical solution, a specific structure and a principle thereof are not described in detail herein again.

In an embodiment, the first switching switch 2 adopts a pressing switch, or the first switching switch 2 adopts a ball-point pen progressive pressing switching switch, which is simple and reliable in structure. The pressing switching switch is an existing mature technology, which is not described in detail herein again. In addition, the first mounting cavity 12 is disposed in a handle of the showerhead main body 1, and the first switching switch 2 is disposed on one side facing a user, to facilitate use.

In an embodiment, the second mounting cavity 13 is disposed on a back portion of the showerhead head portion, and the second switching switch 3 is a push button 32 switch, which is more in line with gripping and switching manners of a user for the showerhead during use of the spray gun water.

In the embodiment, the second switching switch 3 includes a swinging docking pipe 31, a water inlet end of the swinging docking pipe 31 is docked with a water outlet end of the spray gun water passing channel 16 in a swinging manner through a ball head, and a side wall, communicated with the spray gun water outlet channel 17, of the second mounting cavity 13 is of an arc shape and is concentrical with the ball head. A swinging plug 311 is disposed at a water outlet end of the swinging docking pipe 31, and an end surface of the swinging plug 311 is also of an arc shape and abuts against the side wall to perform a reciprocating movement. The end surface of the swinging plug 311 is provided with a water passing hole 312, and the water passing hole 312 is communicated or staggered with the spray gun water outlet channel 17 through swinging of the swinging docking pipe 31, so that the swinging docking pipe 31 can allow water to pass through and can play a role of switching to discharge water or suspend water.

Alternatively, in another embodiment, the second switching switch 3 includes a swinging rod. One end of the swinging rod is rotatably mounted in the second mounting cavity 13, the other end thereof is provided with a swinging plug 311, the swinging plug 311 is tightly attached to a bottom surface of the second mounting cavity 13 to move, and a movement trajectory of the swinging plug 311 is provided with a communicating hole that is between the spray gun water outlet channel 17 and the second mounting cavity 13, so that switching of a spray gun water path is implemented through swinging of the swinging rod.

Based on the above embodiments, in an embodiment, the swinging plug 311 is provided with a convex column 313, the second switching switch 3 further includes a push button 32, the push button 32 is slidably mounted on the showerhead head portion through a sliding groove, and the push button 32 is provided with an inclined groove 321 allowing the convex column 313 to be inserted, to facilitate a switching operation. A movement direction of the push button 32 is parallel to a plane at which a central axis of a handle is located. Preferably, the push button 32 is slidably mounted in the sliding groove through an undercut. The push button 32 drives the swinging plug 311 to move through the inclined groove 321 and the convex column 313, and the movement trajectory of the swinging plug 311 is perpendicular to the plane at which the central axis of the handle is located.

The showerhead provided in the present invention has a showerhead water function and a spray gun water function. During use, the first switching switch 2 may be used to implement switching between the showerhead water and the spray gun water, and the second switching switch 3 may be used to switch to discharge the spray gun water or form the water suspension state, thereby meeting a requirement of controlling water suspension at a showerhead end of the user. In addition, switching structures of the spray gun water and the showerhead water are independent of each other, which may avoid incorrect use of the user.

In the description of the present invention, it should be understood that the orientations or positional relationships indicated by the terms “center”, “longitudinal”, “transverse”, “length”, “width”, “thickness”, “up”, “down”, “front”, “back”, “left”, “right”, “vertical”, “horizontal”, “top”, “bottom”, “inside”, “outside”, “clockwise”, “counter-clockwise”, “axial”, “radial”, “circumferential”, and the like are in accordance with those shown in the accompanying drawings and intended only for the convenience of describing the present invention and simplifying the description rather than for indicating or implying that the referred device or element must be provided with a particular orientation or constructed and operated in a particular orientation; therefore, they should not be construed as limiting the present invention.

Furthermore, the terms “first” and “second” are intended only for descriptive purposes and should not be construed as indicating or implying their relative importance or implying the quantity of technical features indicated. Therefore, defining a feature with “first” and “second” can explicitly or implicitly indicate that at least one of such features is included. In the description of the present invention, “a plurality of” refers to at least two, for example, two or three, unless otherwise specifically defined.

In the present invention, unless otherwise expressly specified and defined, the terms “mounted”, “attached”, “connected”, “fixed”, and the like should be understood in a broad sense, for example, a connection may be a fixed connection, a detachable connection, or an integral connection; it may be a mechanical connection, an electrical connection, or a communication between each other; it may be a direct connection or an indirect connection via an intermediate medium; and it may be a connection between two elements or an interaction between two elements, unless otherwise expressly defined For those of ordinary skill in the art, the specific meanings of the above terms in the present invention can be understood on a case-by-case basis.

In the present invention, unless otherwise expressly specified and defined, a first feature being “above” or “below” a second feature may indicate a direct contact between the first and second features or an indirect contact between the first and second features via an intermediate medium. Furthermore, a first feature being “above”, “over” or “on” a second feature may indicate that the first feature is directly or diagonally above the second feature, or simply indicate that the first feature is higher in level than the second feature. A first feature being “below”, “beneath” or “under” a second feature may indicate that the first feature is directly or diagonally beneath the second feature, or simply indicate that the first feature is lower in level than the second feature.

In the present invention, the terms such as “an embodiment”, “some embodiments”, “example”, “specific example”, and “some examples” mean that a specific feature, structure, material, or characteristic described in conjunction with the embodiment or example is included in at least one embodiment or example of the present invention. In this specification, the schematic expressions of the above terms do not necessarily refer to the same embodiment or example. Moreover, the specific feature, structure, material, or characteristic described may be combined in any suitable manner in any one or more embodiments or examples. In addition, different embodiments or examples described in the specification and features of different embodiments or examples may be combined and integrated by a person skilled in the art without contradicting each other.

Although the above embodiments have been shown and described, it can be understood that the above embodiments are examples and shall not be construed as a limitation on the present invention. Changes, modifications, substitutions, and variants made by those of ordinary skill in the art on the above embodiments shall fall within the protection scope of the present invention.

What is claimed is:

1. A multi-functional showerhead, comprising a showerhead main body, a first switching switch, and a second switching switch, wherein
the showerhead main body is provided with a water inlet channel, a first mounting cavity, a second mounting cavity, a rotating switching water outlet panel, a showerhead water passing channel, a spray gun water passing channel, and a spray gun water outlet channel; and the water inlet channel is communicated with a water inlet of the first mounting cavity, the rotating switching water outlet panel is communicated with the first mounting cavity through the showerhead water passing channel, the second mounting cavity is communicated with the first mounting cavity through the spray gun water passing channel, the spray gun water outlet channel is communicated with the second mounting cavity, and a spray gun water outlet nozzle communicated with the spray gun water outlet channel is circumferentially disposed on a showerhead head portion of the showerhead main body; and
the first switching switch is mounted in the first mounting cavity, and the water inlet channel is communicated with the showerhead water passing channel or the spray gun water passing channel through a switching action of the first switching switch; and the second switching switch is mounted in the second mounting cavity and is provided with a spray gun water gear and a water suspension gear, and the spray gun water passing channel is communicated with the spray gun water outlet nozzle or disconnected with the spray gun water outlet nozzle to form a water suspension state through a switching action of the second switching switch.

2. The multi-functional showerhead according to claim 1, wherein the first switching switch adopts a pressing switch, or the first switching switch adopts a ball-point pen progressive pressing switching switch.

3. The multi-functional showerhead according to claim 2, wherein the first mounting cavity is disposed in a handle of the showerhead main body, and the first switching switch is disposed on one side facing a user.

4. The multi-functional showerhead according to claim 1, wherein the second mounting cavity is disposed on a back portion of the showerhead head portion, and the second switching switch is a push button switch.

5. The multi-functional showerhead according to claim 4, wherein the second switching switch comprises a swinging docking pipe, a water inlet end of the swinging docking pipe is docked with a water outlet end of the spray gun water passing channel in a swinging manner through a ball head, and a side wall, communicated with the spray gun water outlet channel, of the second mounting cavity is of an arc shape and is concentrical with the ball head; and a swinging plug is disposed at a water outlet end of the swinging docking pipe, an end surface of the swinging plug is also of an arc shape and abuts against the side wall to perform a reciprocating movement, the end surface of the swinging plug is provided with a water passing hole, and the water passing hole is communicated or staggered with the spray gun water outlet channel through swinging of the swinging docking pipe.

6. The multi-functional showerhead according to claim 4, wherein the second switching switch comprises a swinging rod, one end of the swinging rod is rotatably mounted in the second mounting cavity, the other end thereof is provided with a swinging plug, the swinging plug is tightly attached to a bottom surface of the second mounting cavity to move, and a movement trajectory of the swinging plug is provided with a communicating hole that is between the spray gun water outlet channel and the second mounting cavity.

7. The multi-functional showerhead according to claim 5, wherein the swinging plug is provided with a convex column, the second switching switch further comprises a push button, the push button is slidably mounted on the showerhead head portion through a sliding groove, the push button is provided with an inclined groove allowing the convex column to be inserted, a movement direction of the push button is parallel to a plane at which a central axis of a handle is located, the push button drives the swinging plug to move through the inclined groove and the convex column, and the movement trajectory of the swinging plug is perpendicular to the plane at which the central axis of the handle is located.

8. The multi-functional showerhead according to claim 7, wherein the push button is slidably mounted in the sliding groove through an undercut.

9. The multi-functional showerhead according to claim 1, wherein three spray gun water outlet channels are formed on an end portion of the showerhead head portion side by side.

10. The multi-functional showerhead according to claim 1, wherein the rotating switching water outlet panel is rotatably mounted on the showerhead head portion, is provided with a water inlet switching cavity, and is further provided with a plurality of showerhead water outlet channels and showerhead water outlet nozzles that are in one-to-one correspondence; and the water inlet switching cavity is communicated with the first mounting cavity through the showerhead water passing channel, and the showerhead water passing channel is communicated with any showerhead water outlet nozzle through a rotating action of the rotating switching water outlet panel.
